(19) United States
(12) Patent Application Publication
(10) Pub. No.: US 2020/0394858 A1
(43) Pub. Date: Dec. 17, 2020

(54) Offline Electronic Lock System with Recording Function

(71) Applicant: Jao Ching Lin, Taipei City (TW)

(72) Inventor: Jao Ching Lin, Taipei City (TW)

(21) Appl. No.: 16/898,690

(22) Filed: Jun. 11, 2020

(30) Foreign Application Priority Data
Jun. 12, 2019 (TW) 108120322

(51) Int. Cl. G07C 9/00

(52) U.S. Cl. CPC G07C 9/00309; G07C 2009/00769; G07C 9/00571

(57) ABSTRACT

An offline electronic lock system with recording function has a control device and multiple key issuing devices. The control device respectively authorizes the key issuing devices to issue at least one electronic key. Each one of the electronic key records an authorization information, the authorization information is corresponding to the key issuing devices that issued the electronic key. The offline electronic lock system with recording function has an electronic lock can be unlocked by the electronic keys. The unlocking record is uploaded to the control device when the electronic lock and the control device are connected, so that the control device can track the authorized source of each electronic key, and confirm the state that the electronic lock.

### FIELD OF INVENTION

The present invention relates to an electronic lock system, and more particularly to an offline electronic lock system having recording function.

### BACKGROUND OF THE INVENTION

A conventional electronic ley for unlocking an electronic lock is issued from a mobile device authorized by a controlling mobile device. When the electronic lock receives an electronic key, the electronic lock is unlocked to control the access of the electronic lock.

In the conventional electronic key system incorporation with the electronic key, the authorized mobile device can determine to issue an electronic key or not, but the issued electronic key is lack of a recording means for identifying log in for unlocking the electronic lock. The controlling mobile device cannot get the information of the condition of the use of the electronic key issued from another mobile device authorized by the controlling mobile device. Therefore, the access control is not confirmed due to lacking of the use information of the electronic key.

### SUMMARY OF THE INVENTION

To solve the aforementioned problems of the conventional electronic lock system, the main objective of the invention is to provide an electronic lock system store an unlocking record including an authorization source. With uploading the unlocking record to a control device, the authorization source of an electronic key can be confirmed.

To achieve the aforementioned objective, the present invention provides an offline electronic lock system including:

a key issuing group having a control device; and at least one key issuing device authorized by the control device to issue at least one electronic key, wherein each one of the at least one electronic key comprises an authorization source information that records a source of the electronic key issued by which one of the at least one of the key issuing device; and

an offline electronic lock comprising a controller, a memory connected with the controller to store an unlocking record in the memory, and a wireless communication module connected with the controller, thereby when the wireless communication module receives one of the at least one electronic key to unlock the electronic lock, a receiving moment and an authorization source of the electronic key are recorded in the unlocking record; and

when the control device is connected with the wireless communication module are connected with each other by a wireless manner, the unlocking record stored in the memory of the electronic lock is uploaded to the control device.

Wherein, each one of the electronic key further comprises an identity information, and when the wireless communication module receives one of the at least one electronic key to unlock the electronic lock, the identity information of the electronic key is recorded in the unlocking record.

Wherein, each one of the control device and the at least one key issuing device is a mobile device having an application program of electronic key, the control device executes the application program of electronic key of the control device to authorize the at least one key issuing device to issue the at least one electronic key, each one of the electronic key is stored in a mobile device having the application program of electronic key, and each mobile device executes the application program of electronic key in the mobile device and is electronically connected with the wireless communication module of the electronic key, and the electronic key stored in each mobile device is sent to and received by the wireless communication module.

Wherein, the control device is a key, an identification reader, or a wireless gateway.

When the present invention is in use, the control device authorize each key issuing device to issue an electronic key for unlocking the electronic lock. When the electronic lock is unlocked, the authorization source information of the electronic key can be recorded in an unlocking record. Consequently, when the control device is connected wirelessly with the electronic lock, the unlocking record can be gained from the electronic lock. With the unlocking record, the using moments and the authorization sources of the electronic keys can be shown off. Thus, the use and authorization source for the electronic lock can be confirmed with the control device.

### BRIEF DESCRIPTION OF THE DRAWINGS

FIG. 1 is a schematic diagram of a preferred embodiment of a key issuing group in accordance with the present invention.

FIG. 2 is a schematic diagram showing an electronic key receiving an electronic key.

FIG. 3 is a block diagram of the electronic lock in accordance with the present invention.

### DETAILED DESCRIPTION OF THE PREFERRED EMBODIMENTS

Other objects, advantages and novel features of the invention will become more apparent from the following detailed description when taken in conjunction with the accompanying drawings.

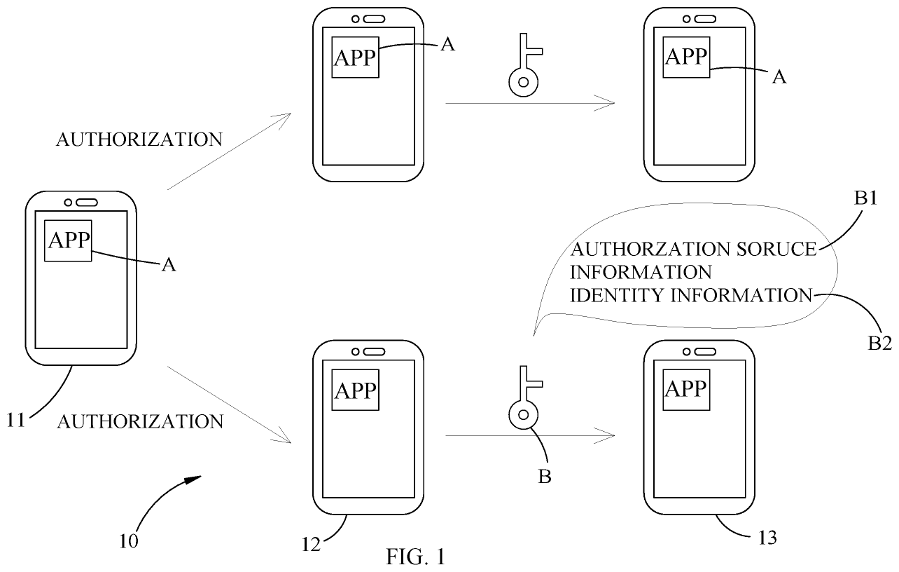

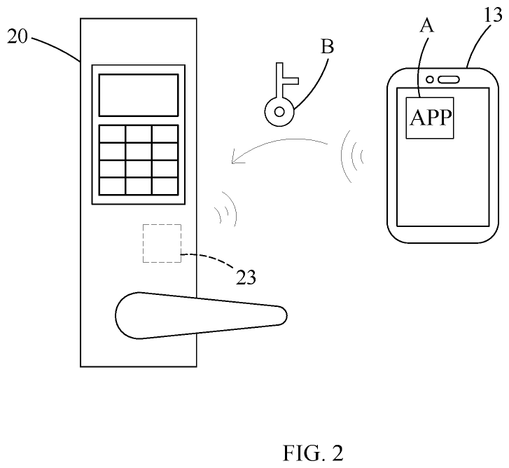

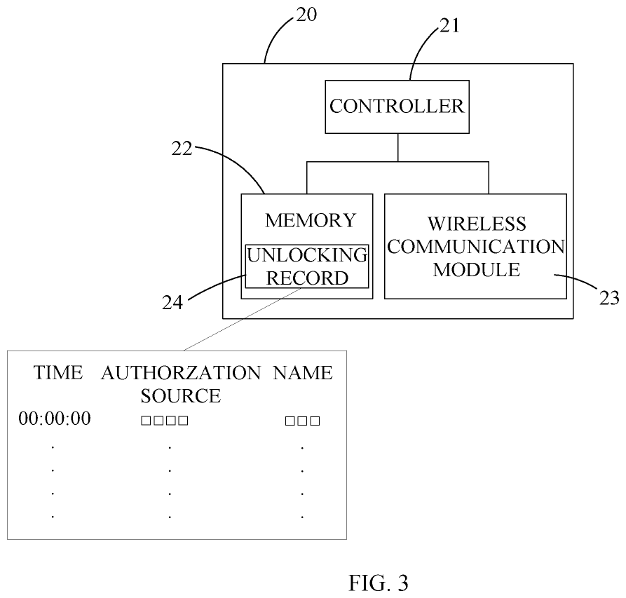

With reference to FIGS. 1 to 3, the present invention is an offline electronic lock system with a recording function and comprises a key issuing group 10 and an electronic lock 20 unlocked by the key issuing group 10.

The key issuing group 10 comprises a control device 11 and at least one key issuing device 12 authorized by the control device to issue at least one electronic key. In the preferred embodiment, the control device 11 is a mobile device, such as a smart phone. The control device 11 may be a key, an identification reader, or a wireless gateway. The control device 11 is installed with an application program of electronic key A. The control device 11 executes the application program of electronic key A to authorize two key issuing devices 12. The two key issuing devices 12 are mobile devices, such as smart phones. Each key issuing device 12 is installed with said application program of electronic key A. each key issuing device 12 executes the application program of electronic key A and is connected wirelessly with the control device 11, the control device 11 can authorize each key issuing device 12 to issue an electronic key. Thus, at least one electronic key B for unlocking the electronic lock 20 can be issued. The wireless manner in the present invention comprise blue tooth or WIFI wireless connection manner.

When each key issuing device 12 issues an electronic key, the application program of electronic key A is executed and is connected with a mobile device 13, such as a smart phone that is installed with and executes the application program of electronic key A. An electronic key B for unlocking the electronic lock 20 is sent wireless to and stored in the mobile device 13, such that the mobile device 13 can execute the application program of electronic key A and is connected wirelessly with the electronic lock 20 to unlock the electronic lock 20. Each electronic key B comprises an authorization source information B1 and selectively comprises an identity information B2. The authorization source information B1 records a source of the electronic key B issued by which one of the at least one of the key issuing device 12. The identify information B2 is the information for identifying the identity of a holder who possessed of the mobile device 13. This information can be gained at the moment before the key issuing device 12 issuing an electronic key and exchanges information with the mobile device 13 and may be name, ID number or phone number.

The electronic lock 20 is a lock without being connected with the Internet and comprises a controller 21, a memory 22, and a wireless communication module 23. The memory 22 and the wireless communication module 23 are connected with the controller 21. The memory 22 stores an access activity may including an unlocking record 24 or a locking record or the like. The wireless communication module 23 may be a blue tooth or WIFI wireless communication module. When the wireless communication module 23 receives one of the at least one electronic key B to unlock or lock the electronic lock 20, a receiving moment, an authorization source information B1 of the electronic key B, and the identify information B2 are recorded in the unlocking record 24. Wherein, the receiving moment is an activity information of the moment of electronic lock 20.

With the wireless communication module 23 receiving same or different electronic keys B for unlocking the electronic lock 20 many times, the unlocking record 24 can record many records of that the electronic lock 20 is unlocked in a time sequence. When the control device 11 executes the application program of electronic key A and is connected wirelessly with the wireless communication module 23 of the electronic lock 20, the unlocking record 24 stored in the memory 22 of the electronic lock 20 is uploaded to the control device 11. Thus, the control device 11 can read the unlocking record 24 and show off the information of the electronic key B unlocking the lock while the control device 11 executes the application program of the electronic key A.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An offline electronic lock system with recording function comprising:
a key issuing group having
a control device; and
at least one key issuing device authorized by the control device to issue at least one electronic key, wherein each one of the at least one electronic key comprises an authorization source information that records a source of the electronic key issued by which one of the at least one of the key issuing device; and
an offline electronic lock comprising
a controller;
a memory connected with the controller to store a record of access activities in the memory; and
a wireless communication module connected with the controller, thereby when the wireless communication module receives one of the at least one electronic key to unlock/lock the electronic lock, an activity information of the moment of lock and an authorization source of the electronic key are recorded in the memory; and
when the control device is connected with the wireless communication module are connected with each other by a wireless manner, the record of access activities stored in the memory of the electronic lock is uploaded to the control device.

2. The offline electronic lock system as claimed in claim 1, wherein each one of the electronic key further comprises an identity information; and
when the wireless communication module receives one of the at least one electronic key to unlock the electronic lock, the identity information of the electronic key is recorded in the memory.

3. The offline electronic lock system as claimed in claim 1, wherein each one of the control device and the at least one key issuing device is a mobile device having an application program of electronic key;
the control device executes the application program of electronic key of the control device to authorize the at least one key issuing device to issue the at least one electronic key;
each one of the electronic key is stored in a mobile device having the application program of electronic key; and
each mobile device executes the application program of electronic key in the mobile device and is electronically connected with the wireless communication module of the electronic key, and the electronic key stored in each mobile device is sent to and received by the wireless communication module.

4. The offline electronic lock system as claimed in claim 1, wherein the control device is a key, an identification reader, or a wireless gateway.
